(19) United States
(12) Patent Application Publication
(10) Pub. No.: US 2015/0336832 A1
(43) Pub. Date: Nov. 26, 2015

(54) SLUDGE PROCESSING EQUIPMENT

(71) Applicant: LEADERMAN & ASSOCIATES CO., LTD., TAIPEI CITY (TW)

(72) Inventors: Rong-Feng TSAI, Yunlin County (TW); Chin-Te CHEN, TAIPEI CITY (TW); Ming-Kuei CHIANG, TAIPEI CITY (TW); Keng-Chuan SUNG, TAIPEI CITY (TW)

(21) Appl. No.: 14/703,866

(22) Filed: May 4, 2015

(30) Foreign Application Priority Data
May 21, 2014 (TW) 103117785

(51) Int. Cl. C02F 11/12; F26B 23/00; F26B 17/14; F26B 3/06; F26B 17/10

(52) U.S. Cl. CPC C02F 11/12; F26B 3/06; F26B 17/10; F26B 17/1433; F26B 23/002; C02F 2201/002; C02F 2303/10

(57) ABSTRACT

A sludge processing equipment includes a separation set, a mixer, a blower and a heat recovery unit. The mixer includes a mixing chamber, a feeder and an air compressor. The mixing chamber is communicated with the separation set. The feeder is configured to deliver a sludge into the mixing chamber. The air compressor is configured to provide a first compressed air to the feeder. The air compressor generates a wasted heat during operation. The blower is configured to provide a transporting airflow to the mixing chamber, so as to deliver the sludge to the separation set. The heat recovery unit is configured to deliver the wasted heat generated by the air compressor to the transporting airflow.

### RELATED APPLICATIONS

This application claims priority to Taiwanese Application Serial Number 103117785, filed May 21, 2014, which is herein incorporated by reference.

### BACKGROUND

1. Technical Field

The present disclosure relates to sludge processing equipment.

2. Description of Related Art

In general, sludge, as discharged from a sewage treatment plant has a very large volume, is considered loose in status and contains a large portion of water. Dehydration treatment of sludge is typical in order to achieve the purposes of volume reduction, stabilization, recycling, and rendering the sludge harmless through treatment. This treatment is also known as the sludge drying process. This process can help to effectively reduce the volume of sludge, in such a way that the transportation fee for the sludge can be significantly reduced. Moreover, this can also facilitate the storage, transportation and utilization of the sludge.

Since the processed sludge has low water content and is relatively stable, the content of microorganisms and bacteria is greatly reduced. Thus, the negative effects of the sludge are alleviated. In practice, after the sludge drying process, the sludge can then be utilized for the manufacturing of products such as fertilizer and soil conditioner. Apart from agricultural utilization, the processed sludge can also be utilized in the aspects like land-filling, incineration or the application of thermal energy. In sum, regardless of the ways to utilize the sludge, the sludge drying process is the first important step. Consequently, this leads to an increasingly important role of the sludge drying process in the overall sludge management system.

The drying of sludge is a process of net energy consumption. Typically, the cost of the energy consumption is greater than 80% of the total operating cost of the sludge drying system. As a result, the reduction of heat loss during the sludge drying process so as to reduce the energy consumption, and thus increase the drying effectiveness is undoubtedly an important issue.

### SUMMARY

A technical aspect of the present disclosure provides sludge processing equipment that can recycle the wasted heat generated by the air compressor during its operation. In this way, the heat loss during the sludge drying process is reduced, such that the drying effectiveness for the sludge is increased.

According to an embodiment of the present disclosure, a sludge processing equipment includes a separation set, a mixer, a blower and a heat recovery unit. The mixer includes a mixing chamber, a feeder and an air compressor. The mixing chamber is communicated with the separation set. The feeder is configured to deliver a sludge into the mixing chamber. The air compressor is configured to provide a first compressed air to the feeder. The air compressor generates a wasted heat during operation. The blower is configured to provide a transporting airflow to the mixing chamber, so as to deliver the sludge to the separation set. The heat recovery unit is configured to deliver the wasted heat generated by the air compressor to the transporting airflow.

In one or more embodiments of the present disclosure, the heat recovery unit includes a hot air collector, a delivery duct and an outlet. The hot air collector is located correspondingly to the air compressor. The delivery duct is connected to the hot air collector. The outlet connects the delivery duct to the blower.

In one or more embodiments of the present disclosure, the feeder includes a feeding channel and a jet channel. The jet channel is communicated with the feeding channel, in which the first compressed air passes through the jet channel, so as to drive the sludge from the feeding channel into the jet channel, and then into the mixing chamber.

In one or more embodiments of the present disclosure, the feeder includes a jet flow air mover. The jet flow air mover is disposed at the feeding channel

In one or more embodiments of the present disclosure, the feeder includes an airflow manifold. The airflow manifold has an air inlet, a first air outlet and a second air outlet, in which the first air outlet is communicated with the jet channel, and the second air outlet is communicated with the jet flow air mover. The air compressor provides the first compressed air to the air inlet.

In one or more embodiments of the present disclosure, the feeder further includes a throttle valve. The throttle valve is connected with the second air outlet and the jet flow air mover, and is configured to control the flow volume of the first compressed air from the second air outlet into the jet flow air mover.

In one or more embodiments of the present disclosure, the sludge processing equipment further includes a vortex device. The vortex device is located at the jet channel, in which the first compressed air first passes through the vortex device, and then to a T-connector of the feeding channel and the jet channel.

In one or more embodiments of the present disclosure, the sludge processing equipment further includes an air accelerator. The air accelerator is located at the jet channel, in which the first compressed air first passes through the air accelerator, and then to a T-connector of the feeding channel and the jet channel.

In one or more embodiments of the present disclosure, the separation set has at least one first separator and at least one second separator. After the transporting airflow passes through the mixing chamber of the mixer, the transporting airflow first passes through the first separator, and then passes through the second separator.

In one or more embodiments of the present disclosure, the first separator includes a casing, an outlet duct and an inlet duct. The outlet duct is connected with the casing. The inlet duct is connected with the casing. The transporting airflow enters into the first separator through the inlet duct, and leaves the first separator through the outlet duct. The sludge process equipment further includes a plurality of air ducts and a compressed air source. The air ducts are connected with a bottom of the casing. The compressed air source is connected with the air ducts. The compressed air source supplies a second compressed air to the bottom of the casing through the air ducts, so as to breakup the sludge located at the bottom of the casing.

In one or more embodiments of the present disclosure, the compressed air source is the air compressor.

In one or more embodiments of the present disclosure, the air compressor is a gas-cooled air compressor.

In one or more embodiments of the present disclosure, the heat recovery unit further includes an air cooling fan. The air cooling fan configured to generate an airflow to absorb the wasted heat generated by the gas-cooled air compressor during flowing through the gas-cooled air compressor.

In one or more embodiments of the present disclosure, the air compressor is a liquid-cooled air compressor. The liquid-cooled air compressor includes a main body, a channel, a pump and a fluid tank. A side of the channel is thermally connected with the main body. The pump is configured to pump and deliver a working fluid in the channel The fluid tank is configured to balance a flow of the working fluid.

In one or more embodiments of the present disclosure, the heat recovery unit includes a heat collector and a plurality of cooling fins. The heat collector is thermally connected with another side of the channel, such that the wasted heat can be delivered from the main body to the heat collector. The cooling fins are disposed in the heat collector. The transporting airflow provided by the blower passes through the cooling fins, such that the wasted heat is delivered to the transporting airflow through the cooling fins.

When compared with the prior art, the embodiments of the present disclosure mentioned above have at least the following advantages:

(1) In the embodiments of the present disclosure as mentioned above, the heat recovery unit is configured to deliver and thermally transfer the wasted heat generated by the air compressor to the transporting airflow. The heated transporting airflow is designed to deliver the sludge from the mixing chamber to the separation set. Therefore, the wasted heat generated by the air compressor is restored and is not wasted to the surroundings. As a result, the heat loss of the wasted heat generated by the air compressor during the sludge drying process is largely reduced. Consequently, the heat energy carried by the wasted heat is effectively used for the sludge drying process, and the drying effectiveness for the sludge is accordingly increased. Hence, the sludge processing equipment is also an Eco-friendly design due to the restoration of wasted heat.

(2) In the embodiments of the present disclosure as mentioned above, since the heat energy carried by the wasted heat is effectively used again for the sludge drying process, thus energy is saved and the drying effectiveness for the sludge is accordingly increased. Hence, the sludge processing equipment is also a design of energy saving.

(3) In the embodiments of the present disclosure as mentioned above, the sludge is driven by the first compressed air from the feeding channel into the jet channel, and then subsequently into the mixing chamber. The sludge is subsequently delivered from the mixing chamber into the separation set by the transporting airflow. The sludge can, therefore, be continuously delivered to the sludge processing equipment for the sludge processing procedures.

(4) In the embodiments of the present disclosure as mentioned above, the compressed air source supplies the second compressed air to the bottom of the casing through the air ducts connected to the bottom of the casing, so as to breakup the sludge and blow away the sludge or powder accumulated at the bottom of the casing. This arrangement allows the chance to re-process the sludge of too big sizes or too large weights. The blockage problem due to the accumulation of the sludge at the bottom of the casing is also avoided.

(5) The processes to deliver the sludge are all carried out in the confined conditions from the feeding channel, to the jet channel, the mixing chamber, and finally into the separation set. Therefore, no particles of the sludge will escape from the sludge processing equipment during the processing of sludge. Consequently, the present disclosure provides the sludge processing equipment with an odorless effect.

### BRIEF DESCRIPTION OF THE DRAWINGS

The disclosure can be more fully understood by reading the following detailed description of the embodiments, with reference made to the accompanying drawings as follows:

FIG. 1A is a front view of a sludge processing equipment according to an embodiment of the present disclosure;

FIG. 1B is a plan view of the sludge processing equipment of FIG. 1A;

FIG. 1C is a perspective view of the blower, the heat recovery unit and the air compressor of FIG. 1A;

FIG. 1D is a perspective view of the blower, the heat recovery unit and the air compressor of FIG. 1A according to another embodiment of the present disclosure;

FIG. 2 is a 3-dimensional perspective view of the feeder of FIG. 1A;

FIG. 3 is a sectional view of the jet flow air mover of FIG. 2;

FIG. 4 is a sectional view of a vortex device according to an embodiment of the present disclosure;

FIG. 5 is a sectional view of a vortex device according to another embodiment of the present disclosure;

FIG. 6 is a sectional view of an air accelerator according to an embodiment of the present disclosure;

FIG. 7 is a sectional view of an air accelerator according to another embodiment of the present disclosure;

FIG. 8 is a sectional view of an air accelerator according to a further embodiment of the present disclosure;

FIG. 9 is a sectional view of an air accelerator according to another embodiment of the present disclosure;

FIG. 10 is a 3-dimensional perspective view of the first separator of FIG. 1A; and

FIG. 11 is a 3-dimensional perspective view of the second separator of FIG. 1A.

### DETAILED DESCRIPTION

Drawings will be used below to disclose a plurality of embodiments of the present disclosure. For the sake of clear illustration, many practical details will be explained together in the description below. However, these practical details should not be used to limit the claimed scope. In other words, in some embodiments of the present disclosure, such practical details may not be essential. Some customary structures and elements in the drawings will be schematically shown in a simplified way. Wherever possible, the same reference numbers used in the drawings and the description correspond to the same or similar parts.

Unless otherwise defined, all terms (including technical and scientific terms) used herein are of the same meaning as commonly understood by one of ordinary skills related to the art of the present disclosure. The meaning of the terms, such as those defined in common dictionaries, should be interpreted as having a meaning that is consistent with their meaning in the context of the relevant art and the present disclosure, and will not be interpreted in an idealized or overly formal sense unless expressly so defined herein.

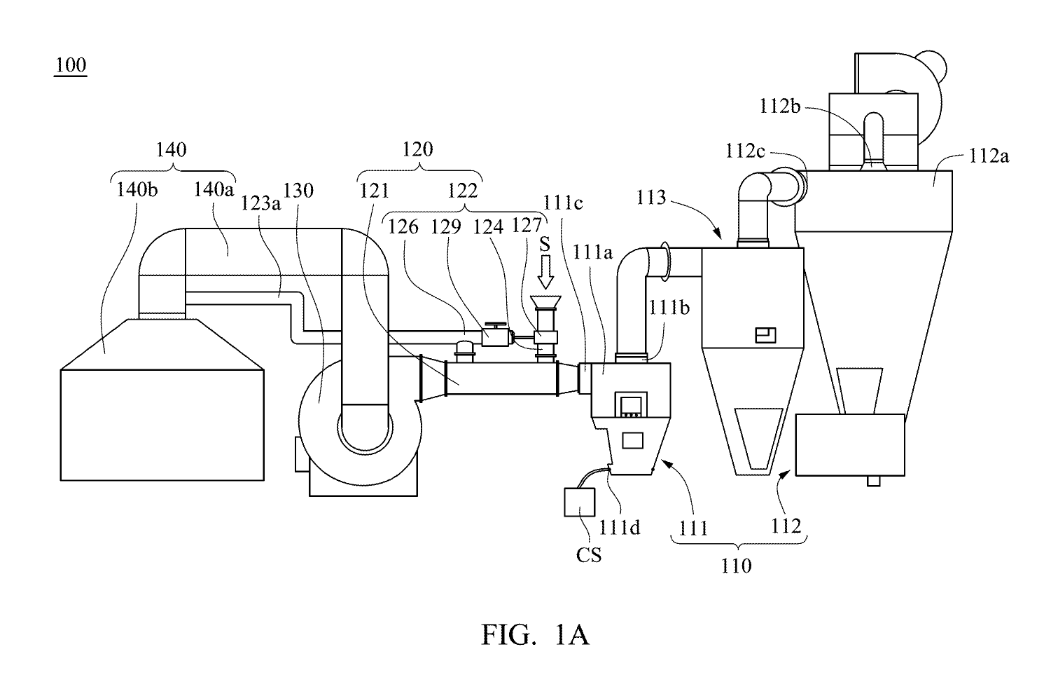

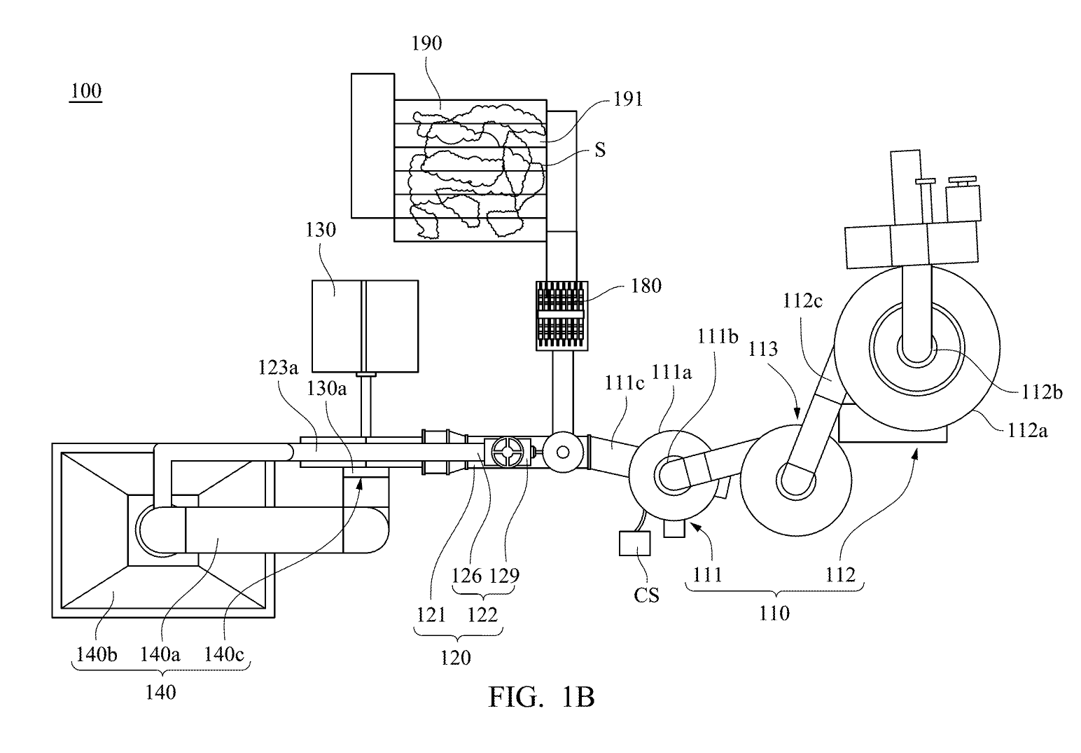

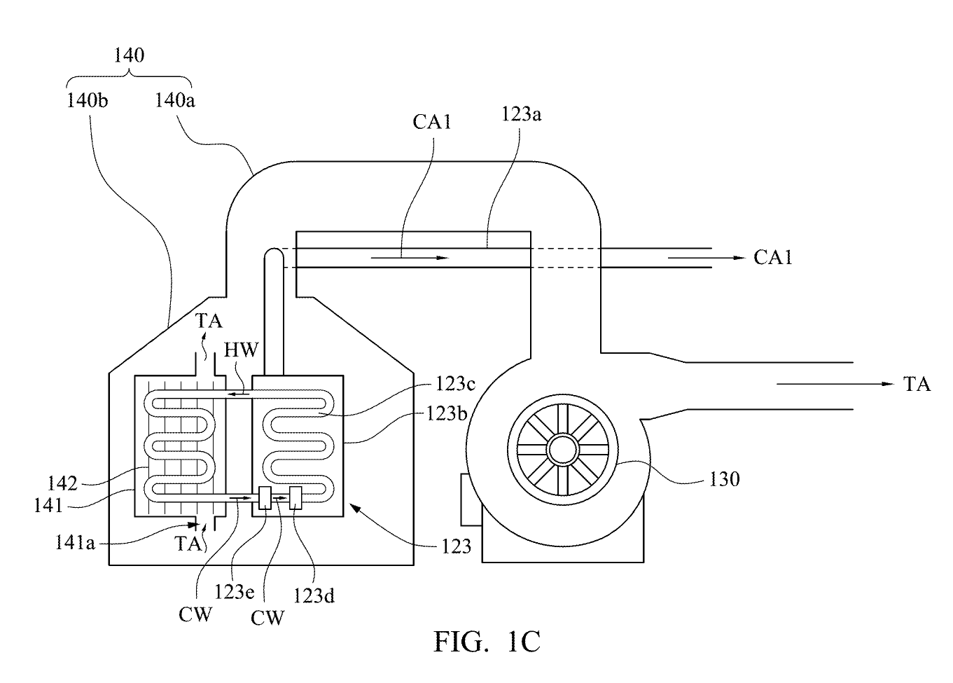

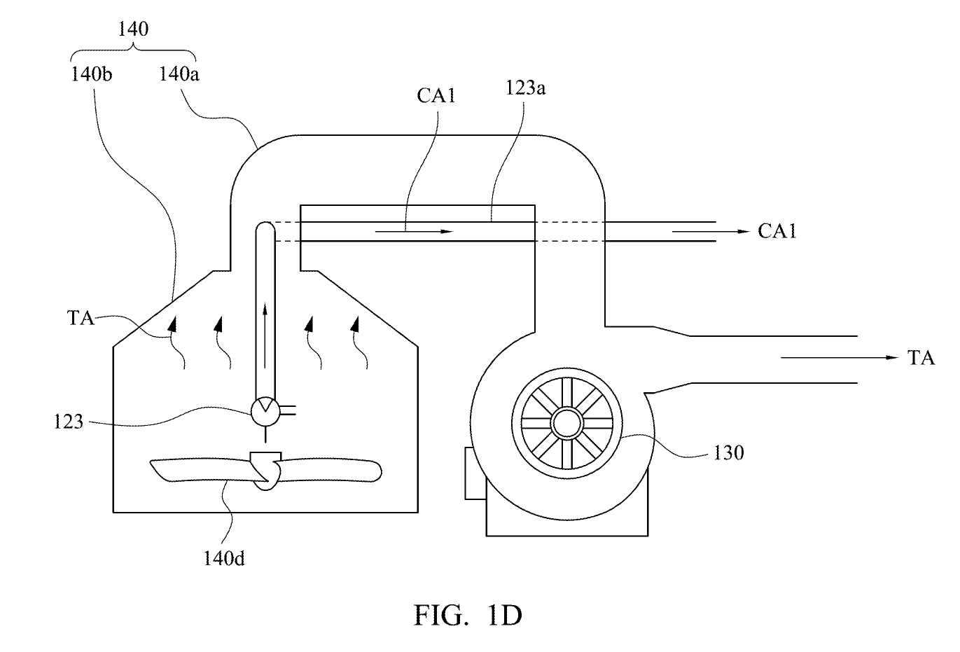

Please refer to FIGS. 1A-1B. FIG. 1A is a front view of a sludge processing equipment 100 according to an embodiment of the present disclosure. FIG. 1B is a plan view of the sludge processing equipment 100 of FIG. 1A. As shown in FIGS. 1A-1B, the sludge processing equipment 100 includes a separation set 110, a mixer 120, a blower 130 and a heat recovery unit 140. The mixer 120 includes a mixing chamber 121, a feeder 122 and an air compressor 123 (not shown in FIGS. 1A-1B). The mixing chamber 121 is communicated with the separation set 110. The feeder 122 is configured to deliver a sludge S into the mixing chamber 121.

Regarding to existing air compressors available in the market, 10-25% of the electric energy input is converted to mechanical energy in a form of compressed air during operation. The remaining 75-90% of the electric energy is converted to heat energy. However, an overheated air compressor cannot operate regularly or continuously. Such heat energy input will inevitably prevent a continuous operation of an air compressor, or reduce its working life like most of the machines. Thus, an appropriate cooling source is always required for a long and continuous operation of air compressors.

Please also refer to FIG. 1C. FIG. 1C is a perspective view of the blower 130, the heat recovery unit 140 and the air compressor 123 of FIG. 1A. As shown in FIGS. 1A-1C, the heat recovery unit 140 includes a delivery duct 140a, a hot air collector 140b and an outlet 140c (only shown in FIG. 1B). The hot air collector 140b is located correspondingly to the air compressor 123. The delivery duct 140a is connected to the hot air collector 140b. The outlet 140c connects the delivery duct 140a to the blower 130. Moreover, in this embodiment, the air compressor 123 is a liquid-cooled air compressor. When the liquid-cooled air compressor operates, the liquid-cooled air compressor pressurizes the ambient air to form the first compressed air CA1. The first compressed air CA1 is subsequently delivered to the feeder 122 of the mixer 120 through the high pressure air duct 123a, so that the sludge S is delivered to the mixing chamber 121 and mixed with the transporting airflow TA.

To be more specific, as shown in FIG. 1C, the liquid-cooled air compressor (the air compressor 123) includes a main body 123b, a channel 123c, a pump 123d and a fluid tank 123e. A side of the channel 123c is thermally connected with the main body 123b. The pump 123d is configured to pump and deliver a working fluid in the channel 123c. The working fluid absorbs the wasted heat generated by the liquid-cooled air compressor and is thermally heated up as the hot working fluid HW. The fluid tank 123e is configured to balance a flow of the working fluid, and to prevent the occurrence of cavitation during the operation of the pump 123d. In this embodiment, the working fluid can be water, pure water, cooling oil or other suitable heat transfer medium (coolant). However, this does not intend to limit the present disclosure.

Furthermore, the heat recovery unit 140 includes a heat collector 141 and a plurality of cooling fins 142. The heat collector 141 is thermally connected with another side of the channel 123c, such that the wasted heat can be delivered from the main body 123b to the heat collector 141 by the working fluid. The cooling fins 142 are disposed in the heat collector 141. The transporting airflow TA provided by the blower 130 passes through the cooling fins 142, such that the wasted heat carried by the hot working fluid HW is then transferred to the transporting airflow TA through the cooling fins 142, and the hot working fluid HW, therefore, changes to the cold working fluid CW.

As shown in FIG. 1C, an end of the heat collector 141 is the entrance 141a for the transporting airflow TA, while another end of the heat collector 141 is communicated with the hot air collector 140b of the heat recovery unit 140.

When the blower 130 operates, the transporting airflow TA is driven to flow into the heat collector 141 through the entrance 141a. The transporting airflow TA absorbs the heat from the hot working fluid HW and becomes the hot transporting airflow TA with a high thermal energy, and then flows through the hot air collector 140b. This hot transporting airflow TA, driven and compressed by the blower 130, becomes the hot transporting airflow TA of high velocity and flows into the mixing chamber 121.

To be more specific, when the liquid-cooled air compressor (the air compressor 123) operates, the pump 123d pumps the cold working fluid CW from the fluid tank 123e and the cold working fluid CW flows into the channel 123c. The cold working fluid CW absorbs the wasted heat generated by the liquid-cooled air compressor and cools down the main body 123b to an appropriate temperature, such that the liquid-cooled air compressor can maintain a long and continuous operation. In practice, the cold working fluid CW absorbs the wasted heat and becomes the hot working fluid HW of 60-80° C.

The hot working fluid HW passes through the channel 123c and transfers the heat to the transporting airflow TA through the cooling fins 142 in the heat collector 141. The hot working fluid HW changes to the cold working fluid CW due to heat exchange, and flows back to the fluid tank 123e, forming a close loop cooling system. The working fluid in this system is configured purely for heat exchange. The working fluid absorbs the wasted heat generated by the liquid-cooled air compressor from the main body 123, and delivers and thermally transfers to the transporting airflow TA at the heat collector 141. Thus, the liquid-cooled air compressor can maintain a long and continuous operation, and the wasted heat generated by the liquid-cooled air compressor is recycled for sludge drying.

On the other hand, as shown in FIG. 1B, the air inlet (not shown in FIG. 1B) of the blower 130 is connected with the heat recovery unit 140 through the air pipe 130a. With reference to the mode of operation of the liquid-cooled air compressor mentioned above, when the blower 130 operates, a large volume of airflow is drawn as the transporting airflow TA to cool down the wasted heat generated by the liquid-cooled air compressor through the cooling fins 142 by forced convection, so as:
(i) to maintain a long and continuous operation; and
(ii) to produce a large volume of transporting airflow TA with a thermal energy.

The transporting airflow TA with a thermal energy is subsequently accelerated by the blower 130 via the hot air collector 140b and the outlet 140c, and transformed into the transporting airflow TA of high velocity and hot temperature associated with high kinetic and thermal energies. The transporting airflow TA subsequently flows into the mixing chamber 121, and mixes with the first compressed air CA1 and sludge S, at which the primary breakup of the sludge S happens.

According to the industrial safety regulations, in this embodiment, the present disclosure sets the operating temperature of the high velocity transporting airflow TA to be 60-70° C. However, this does not intend to limit the present disclosure.

Please refer to FIG. 1D. FIG. 1D is a perspective view of the blower 130, the heat recovery unit 140 and the air compressor 123 of FIG. 1A according to another embodiment of the present disclosure. As shown in FIG. 1D, in this embodiment, the air compressor 123 is a gas-cooled air compressor.

In practical applications, the heat recovery unit 140 further includes an air cooling fan 140d. The air cooling fan 140d is configured to generate an airflow to absorb the wasted heat generated by the gas-cooled air compressor during flowing through the gas-cooled air compressor. Such heated airflow subsequently flows into the blower 130 via the hot air collector 140b and the outlet 140c, and is pressurized as the transporting airflow TA. Provided that the blower 130 can suck an airflow of sufficient rate to cool down the gas-cooled air compressor, the air cooling fan 140d can be omitted or not installed. The other relevant structure and operating details will not be described repeatedly here, since they are all the same as the previous embodiment in which the air compressor 123 is the liquid-cooled air compressor.

To sum up, the air compressor 123 is of two functions:
(i) to provide the first compressed air CA1 to the feeder 122 of the mixer 120, which is used to deliver the sludge S to the mixing chamber 121; and
(ii) to provide the wasted heat, which is used to heat up the transporting airflow TA by the heat recovery unit 140.

As mentioned above, the heat recovery unit 140 is configured to deliver and thermally transfer the wasted heat generated by the air compressor 123 to the transporting airflow TA. The heated transporting airflow TA is designed to deliver the sludge S from the mixing chamber 121 to the separation set 110. Therefore, the wasted heat generated by the air compressor 123 is restored and is not wasted to the surroundings. As a result, the heat loss of the wasted heat generated by the air compressor 123 during the sludge drying process is largely reduced.

Consequently, the heat energy carried by the wasted heat is effectively used for the sludge drying process, and the drying effectiveness for the sludge S is accordingly increased. Hence, the sludge processing equipment 100 is also an Eco-friendly design due to the restoration of wasted heat.

In other words, since the wasted heat generated by the air compressor 123 is restored and is not wasted to the surroundings, the heat energy carried by the wasted heat is effectively used again for the sludge drying process, thus energy is saved and the drying effectiveness for the sludge S is accordingly increased. Hence, the sludge processing equipment 100 is also a design of energy saving.

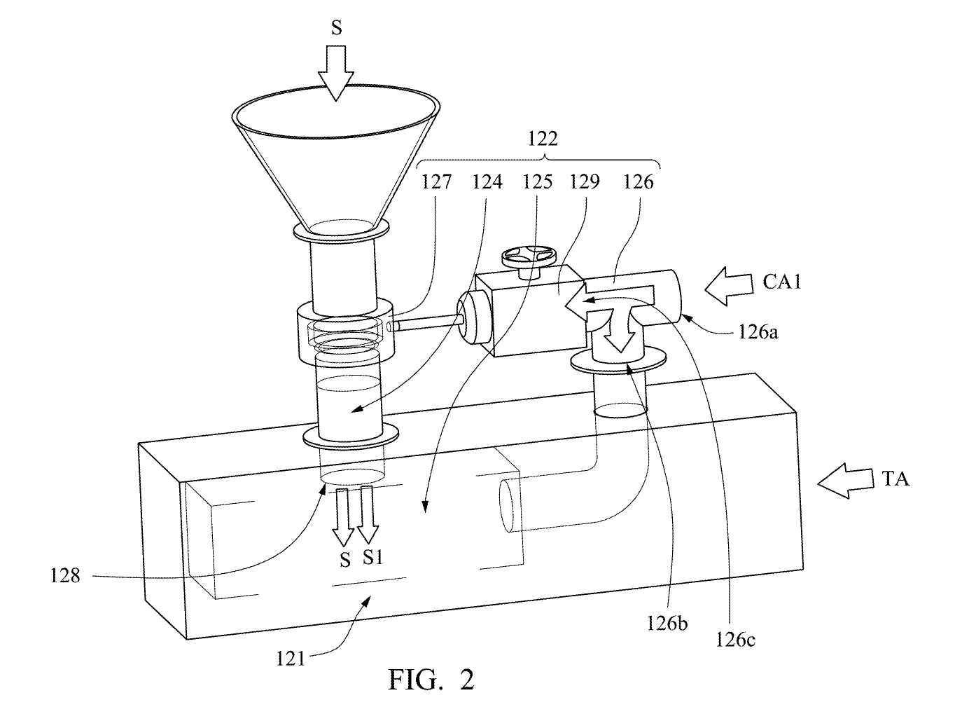

Please refer to FIG. 2. FIG. 2 is a 3-dimensional perspective view of the feeder 122 of FIG. 1A. As shown in FIG. 2, the feeder 122 includes an airflow manifold 126, a feeding channel 124, a jet channel 125, and the jet flow air mover 127. The airflow manifold 126 has an air inlet 126a, a first air outlet 126b and a second air outlet 126c. The jet channel 125 is communicated with the feeding channel 124. The first air outlet 126b is communicated with the jet channel 125, and the second air outlet 126c is communicated with the jet flow air mover 127.

The first compressed air CA1 flows into the feeder 122, and is divided into the downward compressed air CA11 and the forward compressed air CA12 in the airflow manifold 126. The downward compressed air CA11 flows into the jet channel 125 through the first air outlet 126b. The forward compressed air CA12 flows into the jet flow air mover 127 through the second air outlet 126c.

The flow velocity of the downward compressed air CA11 is designed to be higher than that of the air in the feeding channel 124. The pressure in the jet channel 125 is kept to be lower than the pressure in the feeding channel 124. To sum up, the downward compressed air CA11 is used to generate a relatively low pressure field in the jet channel 125. Such pressure difference generates a suction force, which is used to entrain the sludge S from the feeding channel 124 into the jet channel 125, and then into the mixing chamber 121.

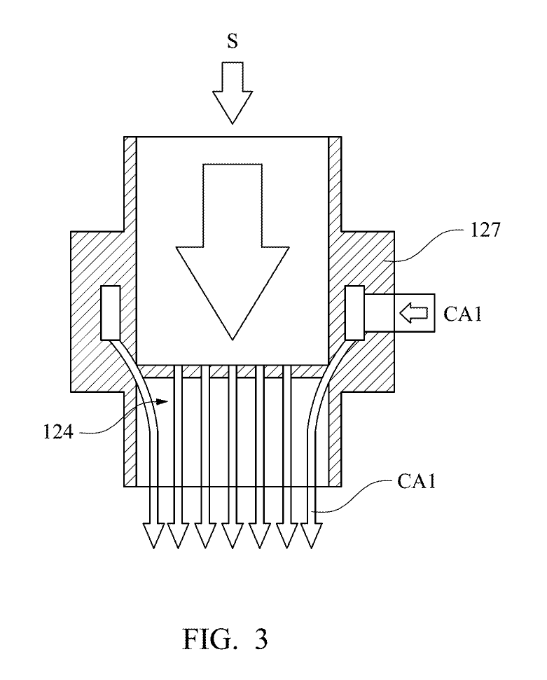

The jet flow air mover 127 is disposed at the feeding channel 124 and its sectional view is shown in FIG. 3. The forward compressed air CA12 flows into the jet flow air mover 127, and is ejected in the form of air jets of high velocities along the inner wall of the feeding channel 124 towards the jet channel 125.

Such air jets of high velocities are designed to create a relatively low pressure region around the center of the inner wall. The low pressure region is useful to entrain the sludge S into the feeding channel 124 and subsequently to the jet channel 125. The air jets also enhance the breakup of the sludge S, resulting in the formation of a sludge granule or powder S1.

In summary, the sludge S is delivered by the suction force due to relatively low pressure field generated by the downward compressed air CA11 at the jet channel 125, and the air jets of high velocities due to the forward compressed air CA12.

The feeder 122 may further include a throttle valve 129, which is connected with the second air outlet 126c and the jet flow air mover 127. The throttle valve 129 is designed to control the flow rate of the forward compressed air CA12 from the second air outlet 126c into the jet flow air mover 127, so as to control the feeding rate of the sludge S entering into the jet channel 125 from the feeding channel 124.

The sludge processing equipment 100 can further include a vortex device 150 to produce different forms of airflow in the jet channel 125. The vortex device 150 is located at the jet channel 125. The downward compressed air CA11 initially passes through the vortex device 150, and subsequently to a T-connector 128 of the feeding channel 124.

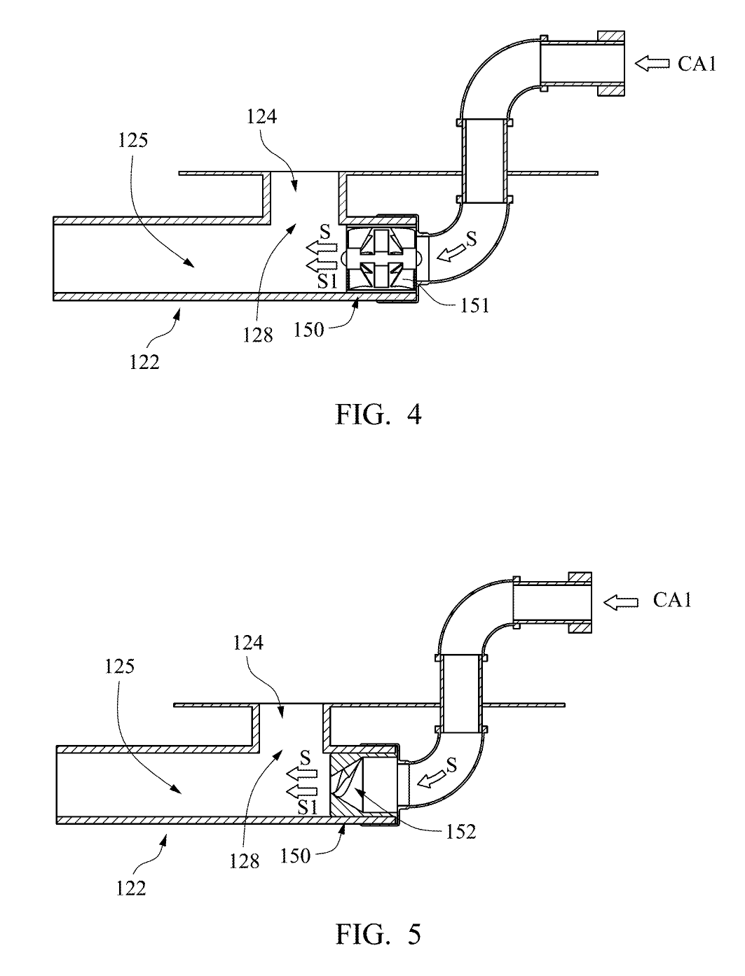

Please refer to FIG. 4. FIG. 4 is a sectional view of a vortex device 150, which can be a passive swirler. The blades 151 of the passive swirler are designed to change the flow pattern of the downward compressed air CA11 from a straight motion into a spiral motion with tangential and axial velocities, so as to breakup and deliver the sludge S into the jet channel 125. The tangential velocity of the downward compressed air CA11 can enhance a further breakup of the sludge S into the sludge granule or powder S1.

Please refer to FIG. 5. FIG. 5 is a sectional view of a vortex device 150, which can be a spiral swirler according to another embodiment of the present disclosure. The spiral swirler is designed to change the flow pattern of the downward compressed air CA11 from a straight motion into a spiral motion with tangential and axial velocities, so as to breakup and deliver the sludge S into the jet channel 125. The tangential velocity of the downward compressed air CA11 can also enhance a further breakup of the sludge S into the sludge granule or powder S1.

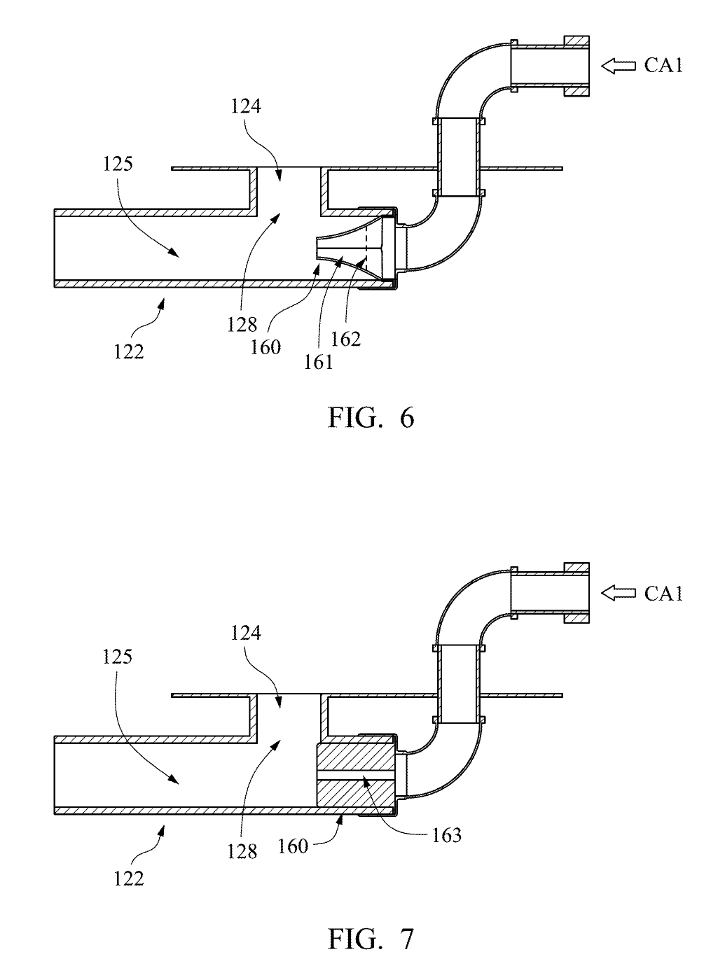

The sludge processing equipment 100 may include an air accelerator 160. FIG. 6 is a sectional view of an air accelerator 160 according to an embodiment of the present disclosure. The air accelerator 160 is located at the jet channel 125 and can be a beak-shaped accessory. The cross-section area 162 of the flow path 161 of the air accelerator 160 reduces gradually towards the T-connector 128. The downward compressed air CA11 of the first compressed air CA1 first passes through the air accelerator 160, and then to the T-connector 128 of the feeding channel 124 and the jet channel 125. Accordingly, the flow velocity of the downward compressed air CA11 is gradually increased during passing through the air accelerator 160. The air accelerator 160 acts like a nozzle, which increases (accelerates) the velocity of the downward compressed air CA11 entering into the jet channel 125.

Please refer to FIG. 7. FIG. 7 is a sectional view of an air accelerator 160 according to another embodiment of the present disclosure. As shown in FIG. 7, the air accelerator 160 can be an orifice. The orifice has at least one through hole 163 therein. The through hole 163 provides a high velocity jet due to the downward compressed air CA11.

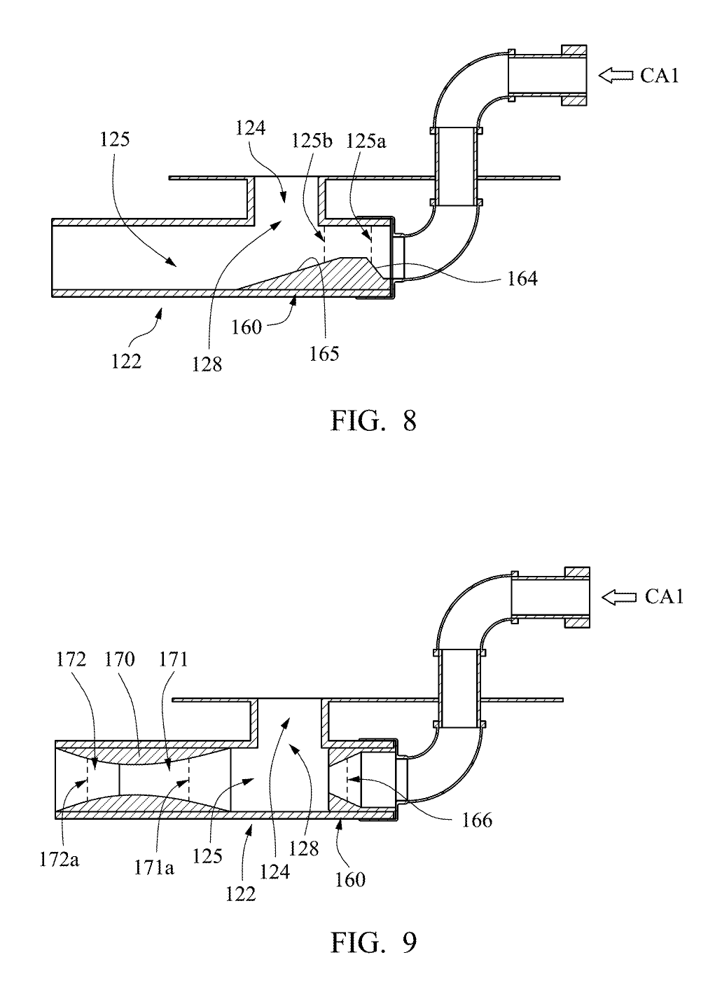

Please refer to FIG. 8. FIG. 8 is a sectional view of an air accelerator 160 according to a further embodiment of the present disclosure. As shown in FIG. 8, the air accelerator 160 can be a combination of tapered surfaces. The combination of tapered surfaces is of a first conical surface 164 and a second conical surface 165. The downward compressed air CA11 first passes through the first conical surface 164, then the second conical surface 165, and then to the T-connector 128 of the feeding channel 124 and the jet channel 125. The first conical surface 164 leads to a gradual decrease of the cross-section 125a of the jet channel 125 towards the T-connector 128, at which the downward compressed air CA11 reaches its highest level. The second conical surface 165 leads to a gradual increase of the cross-section 125b of the jet channel 125 towards the T-connector 128 resulting in a more uniform mixing between the downward compressed air CA11 and the sludge S with the forward compressed air CA12 from the jet channel 125.

Please refer to FIG. 9. FIG. 9 is a sectional view of an air accelerator 160 according to another embodiment of the present disclosure. As shown in FIG. 9, the air accelerator 160 can be an accelerating channel. The accelerating channel is of a cross-section 166, and the cross-section 166 reduces gradually towards the T-connector 128. The flow velocity of the downward compressed air CA11 is, therefore, increased after passing through the accelerator 160. Moreover, in this embodiment, the sludge processing equipment 100 further includes an acceleration duct 170. The downward compressed air CA1 1 first passes through the accelerating channel, and then converges with the forward compressed air CA12 from the jet flow air mover 127 at the T-connector 128. At this point, the downward compressed air CA11 and the forward compressed air CA12 converge to form the first compressed air CA1 again and the first compressed air CA1 flows into the acceleration duct 170.

100751 Furthermore, the acceleration duct 170 is of a first section 171 and a second section 172. The first section 171 is of a cross-section 171a while the section 172 is of a cross-section 172a. The first compressed air CA1 first passes through the first section 171, and then the second section 172. The cross-section 171a gradually reduces towards the direction away from the T-connector 128 while the area of the cross-section 172a gradually increases towards the direction away from the T-connector 128. The flow velocity of the first compressed air CA1 is increased after passing through the first section 171 of the acceleration duct 170. The first compressed air CA1 then enters into the range of the second section 172.

In summary, the sludge S delivered to the mixing chamber 121 is subsequently delivered into the separation set 110 by the transporting airflow TA of high velocity and high temperature by the blower 130. The transporting airflow TA of high velocity and high temperature can breakup the sludge S into the sludge granule or powder S1. At least part of the liquid water (H₂O₁) of the sludge granule or powder S1 is vaporized as gaseous phase water (H₂O_{g}).

As shown in FIGS. 1A-1B, the separation set 110 includes at least one first separator 111 and at least one second separator 112. After passing through the mixing chamber 121 of the mixer 120, the transporting airflow TA first passes through the first separator 111 and then the second separator 112. In this embodiment, as shown in FIGS. 1A-1B, a third separator 113 is further disposed between the first separator 111 and the second separator 112. The third separator 113 is a mechanical apparatus structurally similar to the first separator 111 or the second separator 112, such that the separation set 110 includes three separators in total. The effectiveness of the separation set 110 can be further increased by using three or more separators.

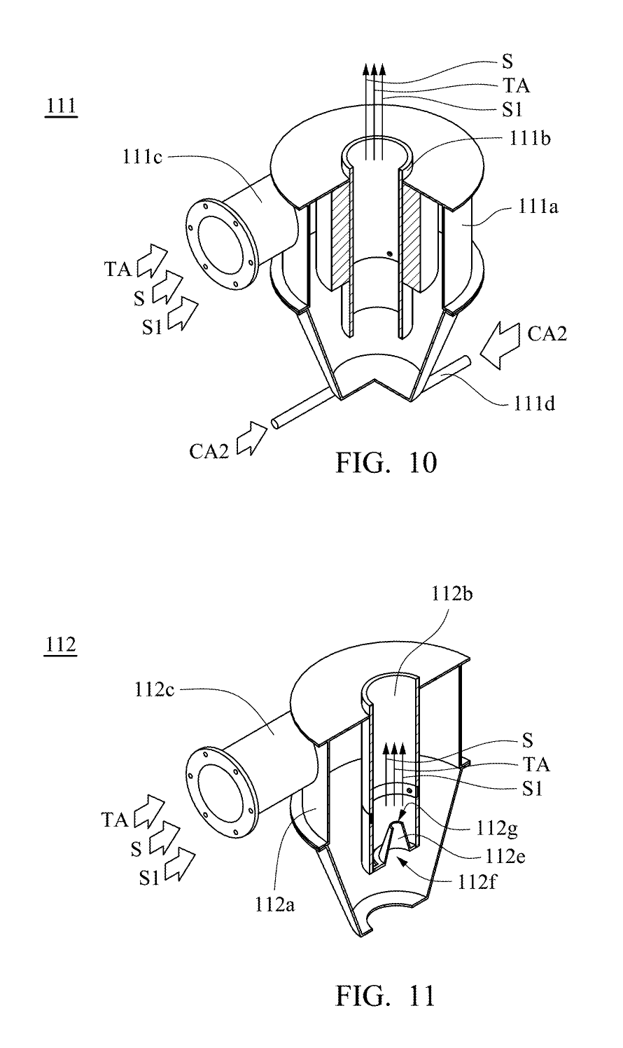

Please refer to FIG. 10. FIG. 10 is a 3-dimensional perspective view of the first separator 111 of FIG. 1A. As shown in FIG. 10, the first separator 111 includes a casing 111a, an outlet duct 111b and an inlet duct 111c. The outlet duct 111b is connected with the casing 111a. The inlet duct 111 c is connected with the casing 111a. After passing through the mixer 120, the transporting airflow TA together with the sludge S and the sludge granule or powder S1 enters into the first separator 111 through the inlet duct 111c, and leaves the first separator 111 through the outlet duct 111b.

It should be noted that at least part of the sludge S, sludge granule or powder S1 may be too big or too weighty to be delivered away from the first separator 111 by the transporting airflow TA and gets accumulated at the bottom of casing 111a, finally leading to the problem of blockage of the flow path. As a result, the sludge process equipment 100 further includes a plurality of air ducts 111d and a compressed air source CS. The air ducts 111d are connected with the bottom of the casing 111a. The compressed air source CS is connected with the air ducts 111d and supplies a second compressed air CA2.

The compressed air source CS is switched on once the sludge S accumulates at the bottom of the casing 111a up to a high level. The second compressed air CA2 of high velocity is purposely designed to breakup the sludge S and blow away the sludge granule or powder S1 accumulated at the bottom of the casing 111a. The second compressed air CA2 solves both the chocking problem of airflow path due to the accumulation of the sludge S at the bottom of the casing 111a and the transporting problem due to oversized sludge S as well. The air compressor 123 can act as the compressed air source CS at the same time in practical operations.

In this embodiment, the shape of the casing 111a of the first separator 111 is a combination of an inverted cone and a barrel. The inlet duct 111c is connected with the casing 111a along the tangential direction of the casing 111a. The sludge S delivered to the casing 111a of the first separator 111 by the transporting airflow TA supplied by the blower 130 can move in a high velocity along the tangential direction of the inner wall of the casing 111a. The centrifugal force due to the tangential velocity throws the larger granules of the sludge S onto the inner wall, and the larger granules of the sludge S falls along the inner wall to the bottom of the casing 111a. The larger granules of the sludge S can be, therefore, separated. Consequently, the transporting airflow TA can deliver the powder or smaller granules of the sludge S to the second separator 112 via the outlet duct 111b of the first separator 111.

Please refer to FIG. 11. FIG. 11 is a 3-dimensional perspective view of the second separator 112 of FIG. 1A. The second separator 112 is similar to the first separator 111 and includes a casing 112a, an outlet duct 112b and an inlet duct 112c. The outlet duct 112b is connected with the casing 112a. The inlet duct 112c is connected with the casing 112a. The transporting airflow TA enters into the second separator 112 through the inlet duct 112c. When the transporting airflow TA enters into the casing 112a through the inlet duct 112c, the powder of small sizes in (of) the sludge S will be guided by the inner wall of the casing 112a and moves tangentially along the inner wall as driven by the transporting airflow TA. At the same time, the powder of small sizes in (of) the sludge S falls along the inner wall of the casing 112a because of its self-weight. Consequently, the powder of small sizes in (of) the sludge S is separated from the transporting airflow TA and is left in the casing 112a, and then the transporting airflow TA associated with the vaporous (gaseous) water leaves the second separator 112 through the outlet duct 112b.

As shown in FIG. 11, the second separator 112 further includes an airflow guider 112e. The airflow guider 112e is located at the end of the outlet duct 112b and is of an inlet 112f and an outlet 112g. The inner diameter of the outlet 112g is smaller than the inner diameter of the inlet 112f. Since the outlet 112a of the airflow guider 112e is located at the center of the outlet duct 112b, the velocity of the flow at the center of the outlet duct 112b is increased, and the pressure along the center of the outlet duct 112b is relatively decreased in contrast. The arrangement of the airflow guider 112e is designed to straighten the flow of the transporting airflow TA and reduce the delivery ability of the transporting airflow TA on the larger sludge S.

Furthermore, as mentioned above, the pressure along the center of the outlet duct 112b is relatively decreased. Thus, the sludge S and the vaporous (gaseous) water in the sludge S in the transporting airflow TA naturally tends to flow along the center of the outlet duct 112b. This means that the sludge S and the vaporous (gaseous) water in the sludge S is kept away from the inner wall of the outlet duct 112b. Therefore, the chance that the sludge S and the vaporous (gaseous) water in the sludge S gets adhered on the inner wall of the outlet duct 112b is accordingly decreased.

As an overview, the processes mentioned above to deliver the sludge S are all carried out in the confined conditions from the feeding channel 124, to the jet channel 125, the mixing chamber 121, and finally into the separation set 110. Therefore, no particles of the sludge S will escape from the sludge processing equipment 100 during the processing of sludge S. Consequently, the present disclosure provides the sludge processing equipment 100 with an odorless effect.

Please go back to FIGS. 1A-1B. The sludge processing equipment 100 further includes a crusher 180. The crusher 180 is configured to breakup the sludge S. The sludge S broken-up by the crusher 180 is delivered to the feeder 122 of the mixer 120.

On the other hand, as shown in FIG. 1B, the sludge processing equipment 100 further includes a distributor of raw material 190. The distributor of raw material 190 is of a plurality of delivery devices 191, configured to supply the sludge S to the crusher 180. The delivery devices 191 can be in the form of augers or belt conveyors. However, the form of the delivery devices 191 does not intend to limit the present disclosure.

In summary, the embodiments of the present disclosure mentioned above have at least the following advantages:

(1) In the embodiments of the present disclosure as mentioned above, the heat recovery unit is configured to deliver and thermally transfer the wasted heat generated by the air compressor to the transporting airflow. The heated transporting airflow is designed to deliver the sludge from the mixing chamber to the separation set. Therefore, the wasted heat generated by the air compressor is restored and is not wasted to the surroundings. As a result, the heat loss of the wasted heat generated by the air compressor during the sludge drying process is largely reduced. Consequently, the heat energy carried by the wasted heat is effectively used for the sludge drying process, and the drying effectiveness for the sludge is accordingly increased. Hence, the sludge processing equipment is also an Eco-friendly design due to the restoration of wasted heat.

(2) In the embodiments of the present disclosure as mentioned above, since the heat energy carried by the wasted heat is effectively used again for the sludge drying process, thus energy is saved and the drying effectiveness for the sludge is accordingly increased. Hence, the sludge processing equipment is also a design of energy saving.

(3) In the embodiments of the present disclosure as mentioned above, the sludge is driven by the first compressed air from the feeding channel into the jet channel, and then subsequently into the mixing chamber. The sludge is subsequently delivered from the mixing chamber into the separation set by the transporting airflow. The sludge can, therefore, be continuously delivered to the sludge processing equipment for the sludge processing procedures.

(4) In the embodiments of the present disclosure as mentioned above, the compressed air source supplies the second compressed air to the bottom of the casing through the air ducts connected to the bottom of the casing, so as to breakup the sludge and blow away the sludge or powder accumulated at the bottom of the casing. This arrangement allows the chance to re-process the sludge of too big sizes or too large weights. The blockage problem due to the accumulation of the sludge at the bottom of the casing is also avoided.

(5) The processes to deliver the sludge are all carried out in the confined conditions from the feeding channel, to the jet channel, the mixing chamber, and finally into the separation set. Therefore, no particles of the sludge will escape from the sludge processing equipment during the processing of sludge. Consequently, the present disclosure provides the sludge processing equipment with an odorless effect.

Although the present disclosure has been described in detail with reference to certain embodiments thereof, other embodiments are possible. Therefore, the spirit and scope of the appended claims should not be limited to the description of the embodiments contained herein.

It will be apparent to the person having ordinary skill in the art that various modifications and variations can be made to the structure of the present disclosure without departing from the scope or spirit of the present disclosure. In view of the foregoing, it is intended that the present disclosure cover modifications and variations of the present disclosure provided they fall within the scope of the following claims.

What is claimed is:

1. A sludge processing equipment, comprising:
a separation set;
a mixer, comprising:
a mixing chamber communicated with the separation set;
a feeder configured to deliver a sludge into the mixing chamber; and
an air compressor configured to provide a first compressed air to the feeder, the air compressor generates a wasted heat during operation;
a blower configured to provide a transporting airflow to the mixing chamber, so as to deliver the sludge to the separation set; and
a heat recovery unit configured to deliver the wasted heat generated by the air compressor to the transporting airflow.

2. The sludge processing equipment of claim 1, wherein the heat recovery unit comprises:
a hot air collector located correspondingly to the air compressor;
a delivery duct connected to the hot air collector; and
an outlet connecting the delivery duct to the blower.

3. The sludge processing equipment of claim 1, wherein the feeder comprises:
a feeding channel; and
a jet channel communicated with the feeding channel, wherein the first compressed air passes through the jet channel, so as to drive the sludge from the feeding channel into the jet channel, and then into the mixing chamber.

4. The sludge processing equipment of claim 3, wherein the feeder comprises:
a jet flow air mover disposed at the feeding channel.

5. The sludge processing equipment of claim 4, wherein the feeder comprises:
an airflow manifold having an air inlet, a first air outlet and a second air outlet, wherein the first air outlet is communicated with the jet channel, the second air outlet is communicated with the jet flow air mover, and the air compressor provides the first compressed air to the air inlet.

6. The sludge processing equipment of claim 5, wherein the feeder further comprises:
a throttle valve connected with the second air outlet and the jet flow air mover, and configured to control the flow volume of the first compressed air from the second air outlet into the jet flow air mover.

7. The sludge processing equipment of claim 3, further comprising:
a vortex device located at the jet channel, wherein the first compressed air first passes through the vortex device, and then to a T-connector of the feeding channel and the jet channel

8. The sludge processing equipment of claim 3, further comprising:
an air accelerator located at the jet channel, wherein the first compressed air first passes through the air accelerator, and then to a T-connector of the feeding channel and the jet channel

9. The sludge processing equipment of claim 1, wherein the separation set has at least one first separator and at least one second separator, after the transporting airflow passes through the mixing chamber of the mixer, the transporting airflow first passes through the first separator, and then passes through the second separator.

10. The sludge processing equipment of claim 9, wherein the first separator comprises:
a casing;
an outlet duct connected with the casing; and
an inlet duct connected with the casing, the transporting airflow enters into the first separator through the inlet duct, and leaves the first separator through the outlet duct,
wherein the sludge processing equipment further comprises:
a plurality of air ducts connected with a bottom of the casing; and
a compressed air source connected with the air ducts, the compressed air source supplies a second compressed air to the bottom of the casing through the air ducts, so as to breakup the sludge located at the bottom of the casing.

11. The sludge processing equipment of claim 10, wherein the compressed air source is the air compressor.

12. The sludge processing equipment of claim 1, wherein the air compressor is a gas-cooled air compressor.

13. The sludge processing equipment of claim 12, wherein the heat recovery unit further comprises:
an air cooling fan configured to generate an airflow to absorb the wasted heat generated by the gas-cooled air compressor during flowing through the gas-cooled air compressor.

14. The sludge processing equipment of claim 1, wherein the air compressor is a liquid-cooled air compressor, and the liquid-cooled air compressor comprises:
a main body;
a channel, a side of the channel is thermally connected with the main body;
a pump configured to pump and deliver a working fluid in the channel; and
a fluid tank configured to balance a flow of the working fluid.

15. The sludge processing equipment of claim 14, wherein the heat recovery unit further comprises:
a heat collector thermally connected with another side of the channel, such that the wasted heat can be delivered from the main body to the heat collector; and
a plurality of cooling fins disposed in the heat collector, wherein the transporting airflow provided by the blower passes through the cooling fins, such that the wasted heat is delivered to the transporting airflow through the cooling fins.
